(19) United States
(12) Patent Application Publication
(10) Pub. No.: US 2010/0158320 A1
(43) Pub. Date: Jun. 24, 2010

(54) METHOD OF MOTION DETECTION USING CONTENT ADAPTIVE PENALTY FUNCTION

(75) Inventor: Ying-Ru Chen, Tainan County (TW)

Correspondence Address: J C PATENTS, 4 VENTURE, SUITE 250, IRVINE, CA, 92618, US

(73) Assignee: HIMAX TECHNOLOGIES LIMITED, Tainan County (TW)

(21) Appl. No.: 12/339,676

(22) Filed: Dec. 19, 2008

(51) Int. Cl. G06K 9/00

(52) U.S. Cl. 382/107

(57) ABSTRACT

A for motion detection using a content adaptive penalty function, adaptive for determining whether a target pixel in a current field is a moving pixel or not, is provided. First, a penalty function is determined according to characteristics of a plurality of neighboring pixels of the target pixel. Next, a plurality of differences between the corresonding neighboring pixels of the target pixel in adjacent fields are calculated. The difference is then weighted by the penalty function according to the magnitude of the difference and the weighted differences are summed together. Finally, the sum of the weighted differences is compared with a sum threshold, so as to determine whether the target pixel is the moving pixel or not.

### BACKGROUND OF THE INVENTION

1. Field of the Invention

The present invention generally relates to a method of motion detection, and more particularly, to a method of motion detection using a content adaptive penalty function.

2. Description of Related Art

With development of multimedia technique, requirement for image quality is substantially increased. The image quality may be influenced by the noises generated during image capturing, signal conversion and signal transmission. Therefore, an image processing technique is required to eliminate the noises that may be sensed by human eyes. The image processing methods for noise reduction commonly include a spatial noise-reduction process and a temporal noise-reduction process.

The spatial noise-reduction process applies a filter to perform spatial filtering process on the pixels of a current field, so as to smooth and soften the field, and reduce a visual perception of the human eyes for the noises. However, such method generally leads to image blurs, which may influence the presentation of image details, such as edges and textures, for example.

The temporal noise-reduction process references information of a previous field, so as to perform temporal filtering process to the pixels of the current field. Since the current field is highly related to the previous field, the temporal noise-reduction process can maintain and reserve details of the field. However, when the temporal filtering process is performed on a moving object within the field, motion blurs may occur on the edges of the moving object. Therefore, a motion detection algorithm is provided to detect the moving pixels in the field, so as to adjust an intensity of the temporal filtering for eliminating the motion blurs.

Generally speaking, motion detection uses differnces between correpsonding pixels in the same parity field to determine whether the designated pixels are moving pixels or not. If the differnece is larger than a preset threshold, it means a variation is occurred in the content of the video and the corresponding pixels are determined as the moving pixels. On the other hand, if the differnece is smaller than the preset threshold, it means no variation is occurred in the content of the video and the corresponding pixels are determined as the static pixels.

Through the motion detection as described above, motion information of pixels of the moving object is obtained and referenced for determining whether to use a spatial interpolation or a temporal interpolation method to generate the required field data, in which the temperal interpolation is used for calculating values of pixels in an area with no moving object and the spacial interpolation is used for calculating values of pixels in an area with the moving object.

As described in the above, the motion detection algorithm is complicated and requires a large amount of calculation. If the moving object is mistakenly detected as a static object, the pixels thereof will be calculated through the temporal interpolation method and accordingly serious noises will be generated. Therefore, there is a need to resist the interference of noises and enhance the difference of the moving object, so as to increase the correctivity of motion detection.

### SUMMARY OF THE INVENTION

In light of the above, the present invention provides a method of motion detection using a content adaptive penalty function, in which the differences between the fields are adaptively weighted so as to increase the accuracy of motion detection.

In order to achieve the above-mentioned or other objects, the present invention provides a method of motion detection using a content adaptive penalty function, adaptive for determining whether a target pixel in a current field is a moving pixel or not. First, a penalty function is determined according to characteristics of a plurality of neighboring pixels of the target pixel. Next, a plurality of differences between the corresonding neighboring pixels of the target pixel in adjacent fields are calculated. The difference is then weighted by the penalty function according to the magnitude of the difference and the weighted differences are summed together. Finally, the sum of the weighted differences is compared with a sum threshold, so as to determine whether the target pixel is the moving pixel or not.

According to an embodiment of the present invention, the penalty function includes a plurality of weights corresponding to different intervals of the magnitude of the difference, in which the magnitude of the difference is seperated into the intervals by a set of difference thresholds.

According to an embodiment of the present invention, in the step of determining the penalty function according to characteristics of the neighboring pixels of the target pixel, if the neighboring pixels of the target pixel are in a smooth area, a first set of difference thresholds is used as the boundaries of the penalty function, and if the neighboring pixels of the target pixel are in a complex area, a second set of difference thresholds is used as the boundaries of the penalty function (S208), in which the difference thresholds in the first set are smaller than those in the second set.

According to an embodiment of the present invention, the set of difference thresholds includes an upper difference threshold and a lower difference threshold.

According to an embodiment of the present invention, in the step of weighting the difference by the penalty function according to the magnitude of the difference, the difference is multiplied by a first weight if the difference is smaller than the lower threshold, multiplied by a second weight if the difference is between the lower threshold and the upper threshold, and multiplied by a third weight if the difference is larger than the upper threshold.

According to an embodiment of the present invention, in the step of calculating the differences between the corresonding neighboring pixels of the target pixel in adjacent fields, the differences between the corresonding neighboring pixels of the target pixel in a curent scan line, a previous scan line, or a next scan line of adjacent odd fields or even fields are calculated.

According to an embodiment of the present invention, in the step of comparing the sum of the weighted differences with the sum threshold to determine whether the target pixel is the moving pixel, the target pixel is determined as the moving pixel if the sum is larger than the sum threshold and the target pixel is determined as a static pixel if the sum is not larger than the sum threshold.

In the present invention, a penalty function is used to weight the differences between the corresonding neighboring pixels of the target pixel in adjacent fields so as to adaptively detect the motion of a moving object. If the difference is relatively small, the difference is regarded as being generated by noises and ignored accordingly. If the difference is relatively large, the difference is regarded as being generated by the motion of an edge of the moving object and weighted more, so as to emphasize the moving object.

In order to make the aforementioned and other objects, features, and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a method for calculating the difference between the same parity according to one embodiment of the present invention.

FIG. 2 is a flowchart illustrating a method of motion detection using a content adaptive penalty function according to one embodiment of the present invention.

FIG. 3 is a flowchart illustrating a method of motion detection using a content adaptive penalty function according to one embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to reduce the size of video data, in a general video compression algorithm, video data is encoded through interlacing method, in which content of scan lines in an odd field and in an even field is complementary to each other. Accordingly, in the process of motion detection, when determining whether a target pixel is a moving pixel or not, the differences between the same odd fields or the same even fields are used to detect the variation between the fields.

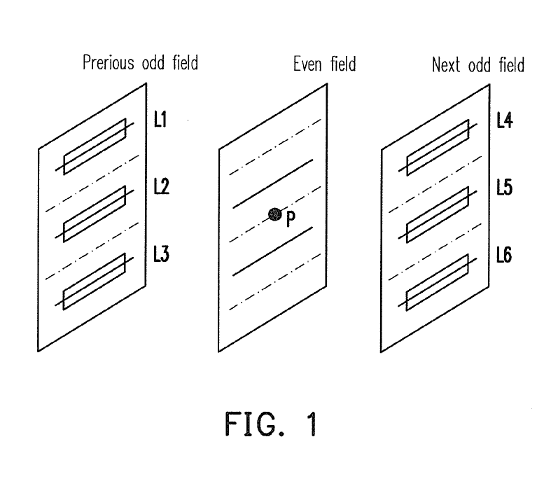

FIG. 1 is a schematic diagram illustrating a method for calculating the difference between the same parity according to one embodiment of the present invention. Referring to FIG. 1, when performing motion detection on a target pixel P in the even field, the difference between the fields can be obtained by calculating a sum of differences between pixels of scan lines in a previous odd field and a next odd field. The aforesaid scan lines include scan lines L2 and L5 that are temporally adjacent to the target pixel P, the scan lines L1 and L3 that are spatially adjacent to the scan lines L2 in the previous odd field, and the scan lines L4 and L6 that are spatially adjacent to the scan line L5 in the next odd field. The rectangular area in the previous odd field and in the next odd field encloses the pixels that can be used for calculating the differences between the fields.

After the differences are calculated, absolute values of the differences are further calculated and summed together. It should be noted herein that, in the aforesaid summation process, not every difference is multiplied by the same weight. To be specific, in the present embodiment, a penalty function that includes a plurality of weights corresponding to different intervals of the magnitude of the difference is used to enhance the differences, in which the magnitude of the difference is seperated into the intervals by a set of difference thresholds. For example, the penalty function can be defined as shown below:

$$Penalty ( i ) = \{ \begin{matrix}0 , & {AD}_{i} \leq Tn \\ 1 , & Tn \leq {AD}_{i} \leq Te \\ 2 , & {AD}_{i} > Te\end{matrix} , \qquad ( 1 )$$

wherein, i represents the designate target pixel, AD represents the absolute value of the difference, Tn represents a lower difference threshold, and Te represents an upper difference threshold. Based on the aforesaid penalty function, the presnet invention provides a method of motion detection by using the penalty function, and the details thereof are described in the following embodiment.

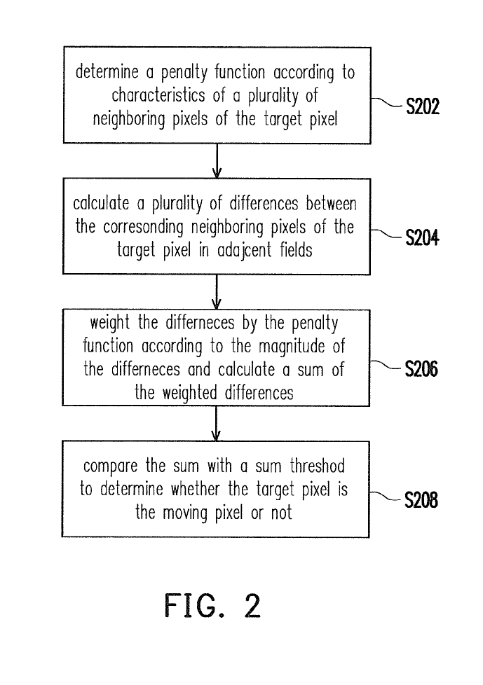

FIG. 2 is a flowchart illustrating a method of motion detection using a content adaptive penalty function according to one embodiment of the present invention. Referring to FIG. 2, the present embodiment is adaptive for determining whether a target pixel in a current field is a moving pixel or not. The steps of the method are as follows.

First, a penalty function is determined according to characteristics of a plurality of neighboring pixels of the target pixel (S202). To be specific, if the neighboring pixels of the target pixel are in a smooth area, then a first set of difference thresholds is used as the boundaries of the penalty function, and if the neighboring pixels of the target pixel are in a complex area, then a second set of difference thresholds is used as the boundaries of the penalty function, in which the difference thresholds in the first set are smaller than those in the second set. That is because the differences between fields resulting from the motion of a moving object in a smooth area are usually smaller than those in the complex area, such that the difference thresholds adopted in the penalty function are also smaller. Accordingly, the penalty function can be regarded as a content adaptive penalty function in the present embodiment.

Next, a plurality of differences between the corresonding neighboring pixels of the target pixel in adjacent fields are calculated (S204). As described in the above embodiment, the neighboring pixels used to calculate the differences are pixels of the scan lines that are temporally adjacent to the target pixel in a previous field and in a next field, in which the number of pixels or the scan lines are not limited herein. The neighboring pixels can also be pixels in a curent scan line, a previous scan line, or a next scan line of adjacent odd fields or even fields.

Further, each of the differences are weighted by the penalty function according to the magnitude of the difference, and then a sum of the weighted differences is calculated (S206). To be specific, the magnitude of the calculated difference is compared with the difference thresholds first so as to determine which interval that the difference is fallen into. Then, the difference is multiplied by the weight corresponding to the determined interval defined in the penalty function, so as to reduce or enhance the influence of the difference for the motion detection.

Finally, the calculated sum of the differences are compared with a sum threshold, so as to determine whether the target pixel is the moving pixel or not (S208). To be specific, if the sum is larger than the sum threshold, then the target pixel is determined as the moving pixel, and if the sum is not larger than the sum threshold, then the target pixel is determined as a static pixel.

Based on the above method of motion detection, the differences resulting from the motion of the edge of the moving object can be enhanced while the differences resulting from the noises can be reduced, such that a better motion detection result can be obtained. It should be noted herein that, for the penalty function, the number and the value of the difference thresholds and the weights corresponding thereto can be given according to the actual requirement, which are not limited in the present embodiment. To make the relation between thed difference and the penalty function more comprehansive, another embodiment is given below for further illustration.

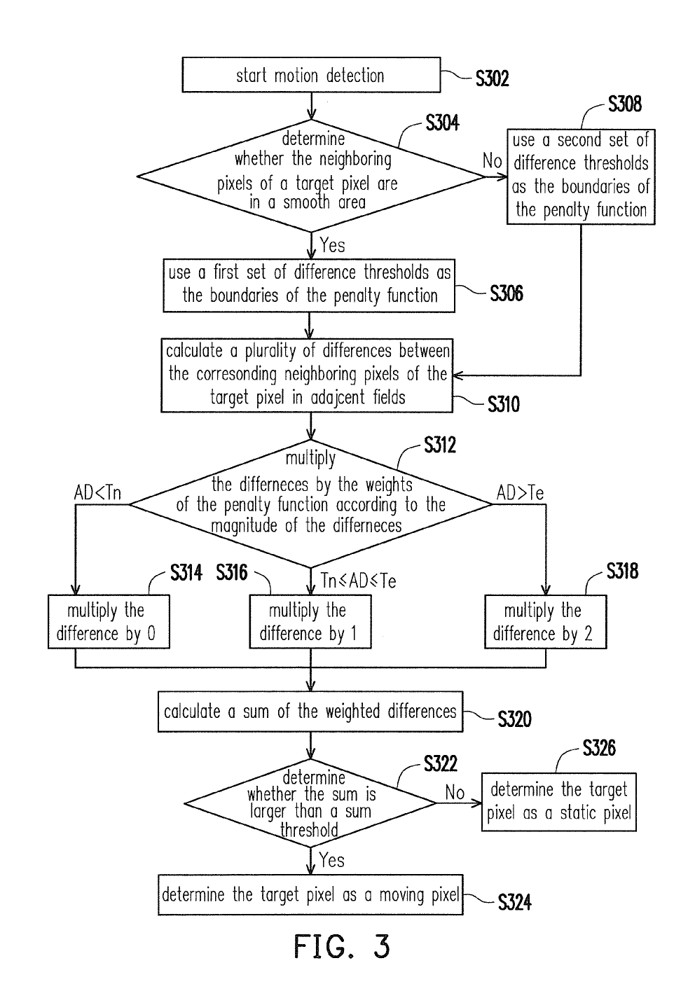

FIG. 3 is a flowchart illustrating a method of motion detection using a content adaptive penalty function according to one embodiment of the present invention. Referring to FIG. 3, the present embodiment is adaptive for determining whether a target pixel in a current field is a moving pixel or not, in which an upper difference threshold and a lower difference threshold are given and the weights corresponding to the differences in different intervals are defined in the penalty function, so as to enhance the differences. The steps of the method are as follows.

When the motion detection starts (S302), it is determined whether the neighboring pixels of the target pixel are in a smooth area (S304). If the neighboring pixels of the target pixel are in the smooth area, then a first set of difference thresholds is used as the boundaries of the penalty function (S306), and if the neighboring pixels of the target pixel are in a complex area, then a second set of difference thresholds is used as the boundaries of the penalty function (S308), in which the difference thresholds in the first set are smaller than those in the second set, such that an appropriate penalty function that fits the variation of neighboring pixels around the target pixel can be adaptively selected.

After the penalty function is defined, a plurality of differences between the corresonding neighboring pixels of the target pixel in adjacent fields are calculated (S310), in which the absolute values of the differences (AD) are also calculated if the differences are negative. As described in the above embodiment, the neighboring pixels can be pixels in a curent scan line, a previous scan line, or a next scan line of adjacent odd fields or even fields, which has been described in the previous embodiment, such that the related content is omitted herein.

The differences are then multiplied by the weights of the penalty function according to the magnitude thereof (S312), in which the penalty function contains a lower threshold (Tn) and an upper threshold (Te), such that the differences (AD) can be separated into three groups and multiplied by three different weights, respectively. To be specific, if the difference (AD) is smaller than the lower threshold (Tn), then the difference (AD) is multiplied by a 0 (S314). Further, if the difference (AD) is between the lower threshold (Tn) and the upper threshold (Te), then the difference (AD) is multiplied by 1 (S316). Moreover, if the difference (AD) is larger than the upper threshold (Te), then the difference (AD) is multiplied by 2 (S318).

After the weighting of differences are completed, all the weighted differences are summed together (S320) and used to determine whether the target pixel is the moving pixel or not. To be specific, it is determined whether the sum is larger than a sum threshold (S322). If the sum is larger than the sum threshold, then the target pixel is determined as the moving pixel (S324), and if the sum is not larger than the sum threshold, then the target pixel is determined as a static pixel (S326).

To sum up, the present invention provides a method of motion detection, in which a content adaptive penalty function is defined and used to enhance the difference between fields so as to remove the interference of noises and magnify the difference generated by the motion of the moving object. Accordingly, the accuracy of motion detection can be increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of motion detection using a content adaptive penalty function, adaptive for determining whether a target pixel in a current field is a moving pixel or not, the method comprising:
determining a penalty function according to characteristics of a plurality of neighboring pixels of the target pixel;
calculating a plurality of differences between the corresonding neighboring pixels of the target pixel in adjacent fields;
weighting the difference by the penalty function according to the magnitude of the difference and calculating a sum of the weighted differences; and
comparing the sum with a sum threshold to determine whether the target pixel is the moving pixel or not.

2. The method of motion detection using a content adaptive penalty function according to claim 1, wherein the penalty function comprises a plurality of weights corresponding to different intervals of the magnitude of the difference, in which the magnitude of the difference is seperated into the intervals by a set of difference thresholds.

3. The method of motion detection using a content adaptive penalty function according to claim 2, wherein the step of determining the penalty function according to characteristics of the neighboring pixels of the target pixel comprises:
if the neighboring pixels of the target pixel are in a smooth area, using a first set of difference thresholds as the boundaries of the penalty function; and
if the neighboring pixels of the target pixel are in a complex area, using a second set of difference thresholds as the boundaries of the penalty function, wherein the difference thresholds in the first set are smaller than those in the second set.

4. The method of motion detection using a content adaptive penalty function according to claim 2, wherein the set of difference thresholds comprises an upper difference threshold and a lower difference threshold.

5. The method of motion detection using a content adaptive penalty function according to claim 4, wherein the step of weighting the difference by the penalty function according to the magnitude of the difference comprises:
multiplying the difference by a first weight if the difference is smaller than the lower threshold;
multiplying the difference by a second weight if the difference is between the lower threshold and the upper threshold; and
multiplying the difference by a third weight if the difference is larger than the upper threshold.

6. The method of motion detection using a content adaptive penalty function according to claim 5, wherein the first weight, the second weight, and the third weight are 0, 1, and 2, respectively.

7. The method of motion detection using a content adaptive penalty function according to claim 1, wherein the step of calculating the differences between the corresonding neighboring pixels of the target pixel in adjacent fields comprises:
calculating the differences between the corresonding neighboring pixels of the target pixel in a curent scan line, a previous scan line, or a next scan line of adjacent odd fields or even fields.

8. The method of motion detection using a content adaptive penalty function according to claim 1, wherein the step of comparing the sum with the sum threshold to determine whether the target pixel is the moving pixel or not comprises:
determining the target pixel as the moving pixel if the sum is larger than the sum threshold; and
determining the target pixel as a static pixel if the sum is not larger than the sum threshold.
